(19) United States
(12) Patent Application Publication
(10) Pub. No.: US 2026/0070332 A1
(43) Pub. Date: Mar. 12, 2026

(54) LIQUID EJECTION HEAD AND INKJET PRINTER

(71) Applicant: RISO Technologies Corporation, Tokyo (JP)

(72) Inventor: Sota HARADA, Mishima Shizuoka (JP)

(21) Appl. No.: 19/230,121

(22) Filed: Jun. 6, 2025

(30) Foreign Application Priority Data
Sep. 10, 2024 (JP) 2024-156640

(51) Int. Cl. B41J 2/045; B41J 2/14

(52) U.S. Cl. CPC B41J 2/04581; B41J 2/04541; B41J 2/04588; B41J 2/14201; B41J 2002/14483; B41J 2002/14491

(57) ABSTRACT

A liquid ejection head includes nozzles, pressure chambers each storing liquid and communicating with a nozzle, a volume of each chamber being varied to eject the liquid from the nozzle, piezoelectric elements each configured to vary the volume in response to a drive signal, an integrated circuit configured to generate the signal, a first line through which a first voltage is supplied, its voltage level being held constant, a second line through which a second voltage is supplied, its voltage level varying, a first capacitor connected to the first line, and a first switch circuit configured to selectively connect the integrated circuit to either the first or second lines. The integrated circuit generates the signal using either the first or second voltage, and a capacitance of the first capacitor is no less than a total capacitance of the piezoelectric elements.

### CROSS REFERENCE TO RELATED APPLICATION

This application is based upon and claims the benefit of priority from Japanese Patent Application No. 2024-156640, filed on Sep. 10, 2024, the entire contents of which are incorporated herein by reference.

### FIELD

Embodiments described herein relate generally to a liquid ejection head and an inkjet printer.

### BACKGROUND

A liquid ejection head that supplies a predetermined amount of liquid to a predetermined position is known. The liquid ejection head is installed in, for example, an inkjet printer, a 3D printer, or a dispensing apparatus. The inkjet printer ejects ink droplets from an inkjet head to form an image or the like on a surface of a recording medium. The 3D printer ejects droplets of a shaping material from a shaping material ejection head, then cures the shaping material to form a 3D shaped article. The dispensing apparatus ejects droplets of a sample to supply a predetermined amount to a plurality of containers.

The liquid ejection head has a plurality of channels for ejecting the liquid. Each of the channels is provided with a nozzle for ejecting the liquid, a pressure chamber in communication with the nozzle, and an actuator for changing the volume of the pressure chamber. The liquid ejection head selects one of the channels and applies a drive waveform to the corresponding actuator. When the actuator is driven, the volume of the pressure chamber changes, ejecting the liquid from the nozzle.

A plurality of fixed voltages are applied to the liquid ejection head, and the drive circuit generates the drive waveform by selecting an appropriate fixed voltage. Generating the drive waveform inside the liquid ejection head can reduce the size and cost of the integrated circuit (IC), which incorporates a plurality of channel drive circuits for multiple channels.

In such a liquid ejection head, the drive waveform is generated by turning ON and OFF a switch provided for the drive circuit at high speed. Therefore, the switch generates heat, limiting the use of such a liquid ejection head in heat-sensitive applications or environments.

To address this, a liquid ejection head has been proposed in which a plurality of drive waveforms, each providing a different volume of the liquid to be ejected, are generated outside the head, supplied to the head, and then selected by the drive circuit. Such a configuration enables the effective generation of a plurality of drive waveforms that are different from each other.

However, when the drive waveforms are generated outside the head, the distance between the generation source of the drive waveforms and the drive circuit causes the waveforms to deteriorate before reaching the drive circuit due to wiring resistance, connector contact resistance, and the like. Therefore, such a head is unsuitable for applications that require steep waveforms.

Therefore, there is a need for a liquid ejection head that can be used in a wide range of environments and applications.

### BRIEF DESCRIPTION OF THE DRAWINGS

FIG. 1 is a block configuration diagram of an inkjet printer provided with an inkjet head according to a first embodiment.

FIG. 2 is an appearance perspective view of the inkjet head.

FIG. 3 is a cross-sectional view of a piezoelectric actuator provided to the inkjet head.

FIG. 4 is a circuit configuration diagram of a related-art inkjet head.

FIG. 5 is a circuit configuration diagram of a related-art inkjet head.

FIG. 6 is a circuit configuration diagram of the inkjet head.

FIG. 7 is a circuit configuration diagram of an inkjet head according to a modified example.

FIG. 8 is a circuit configuration diagram of an inkjet head according to a second embodiment.

FIG. 9 is a circuit configuration diagram of an inkjet head according to a modified example.

### DETAILED DESCRIPTION

A liquid ejection head and an inkjet printer are provided that can be used in a wide range of environments and applications.

In general, according to one embodiment, a liquid ejection head comprises: a nozzle plate including a plurality of nozzles; a plurality of pressure chambers, each of which is capable of storing liquid and communicates with a corresponding one of the nozzles, a volume of each pressure chamber being varied to eject the liquid from the corresponding nozzle; a plurality of piezoelectric elements, each of which is configured to vary the volume of a corresponding one of the pressure chambers in response to a drive signal; an integrated circuit configured to generate the drive signal; a first power supply line through which a first voltage is supplied, a voltage level of the first voltage being held constant; a second power supply line through which a second voltage is supplied, a voltage level of the second voltage begin varied and applicable to all of the piezoelectric elements; a first capacitor connected to the first power supply line; and a first switch circuit configured to selectively connect the integrated circuit to either the first or second power supply lines. The integrated circuit generates the drive signal using either the first voltage or the second voltage supplied through one of the first and second power supply lines that is selected by the first switch circuit, and a capacitance of the first capacitor is no less than a total capacitance of all of the piezoelectric elements.

Embodiments of this disclosure will be described in detail with reference to the accompanying drawings. The embodiments will be described citing an inkjet head as an example of a liquid ejection head. It should be noted that in each of the drawings, the same elements are denoted by the same reference numerals.

### First Embodiment

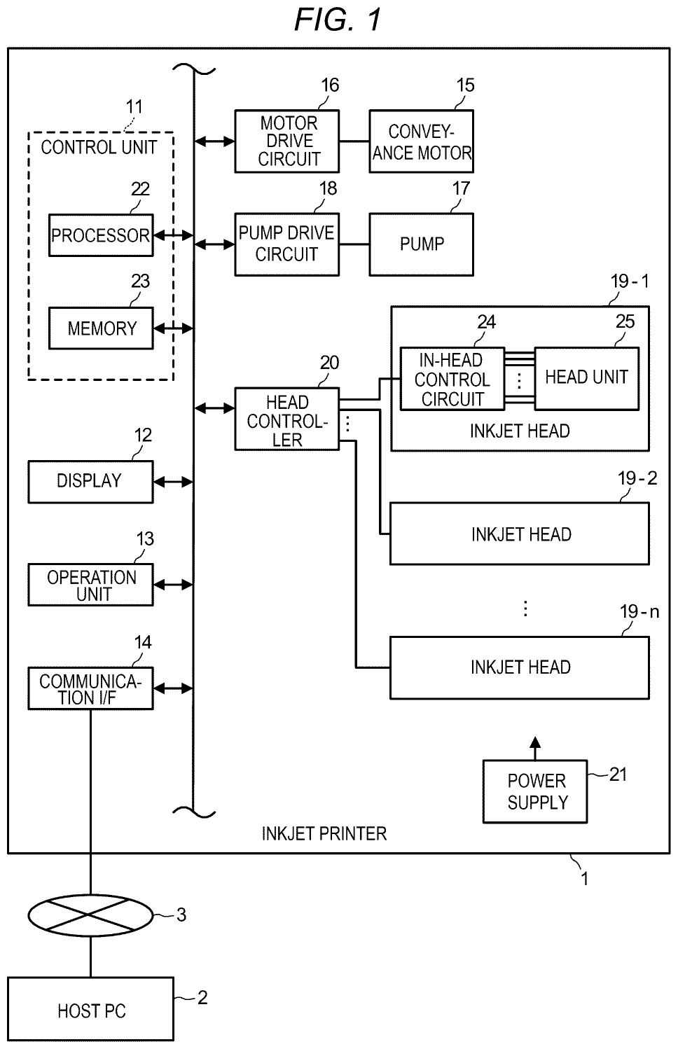

FIG. 1 is a block configuration diagram of an inkjet printer 1 according to a first embodiment. The inkjet printer 1 performs image formation on a print medium as a recording medium while conveying the print medium.

As shown in FIG. 1, the inkjet printer 1 includes a control unit 11, a display 12, an operation unit 13, a communication interface 14, a conveyance motor 15, a motor drive circuit 16, a pump 17, a pump drive circuit 18, a plurality of inkjet heads 19-1, 19-2, . . . , and 19-n according to the first embodiment, a head controller 20, and a power supply 21. Further, the inkjet printer 1 includes a conveyance mechanism, a paper cassette, and a catch tray all not shown. It should be noted that “interface” is abbreviated as “IF” in FIG. 1. Further, in the following description, the plurality of inkjet heads 19-1 to 19-n are described simply as “inkjet head 19” when describing them without distinction.

The control unit 11 includes a processor 22 and a memory 23 to perform a variety of types of control of the inkjet printer 1. The processor 22 is an arithmetic element which executes arithmetic processing. The processor 22 executes a variety of types of processing according to a program and data to be used in the program stored in, for example, the memory 23. The memory 23 stores the program, the data to be used in the program, and so on in a rewritable manner.

The display 12 is a display device such as a liquid crystal display, and displays an image in accordance with a video signal input from the processor 22, a graphic controller, not shown, for performing image processing, or the like.

The operation unit 13 generates an operation signal in response to an operation of a user. The operation unit 13 is, for example, a touch sensor, a numerical keypad, a power key, a paper feed key, a variety of function keys, or a keyboard, or any combination thereof. The touch sensor is, for example, a resistive-film touch sensor or a capacitive touch sensor. The touch sensor acquires information representing a position designated in a certain region. Further, the touch sensor may be used as a touch panel which is integrally configured with the display 12 and the touch sensor disposed on an upper surface of the display 12. In this case, the touch sensor generates a signal representing a touched position on a screen displayed on the display 12.

The communication interface 14 is an interface circuit for communicating with an external apparatus. In the present embodiment, the communication interface 14 is used, for example, for communication with at least one host PC 2 which transmits print data to the inkjet printer 1. The communication interface 14 communicates with the host PC 2 via a network 3 configured with wired or wireless communication, such as a local area network (LAN).

The conveyance motor 15 rotates to thereby function as a drive source for a conveyance mechanism, not shown, for conveying the print medium. The conveyance mechanism is constituted by a conveyance belt for conveying the print medium, a plurality of rollers which support the conveyance belt, a guide, and so on. The conveyance motor 15 rotates the drive roller to move the conveyance belt. The print medium moves on the conveyance path defined as the guide arranged around the conveyance belt.

The motor drive circuit 16 drives the conveyance motor 15 in accordance with a conveyance control signal input from the control unit 11. Due to the motor drive circuit 16, the conveyance motor 15, and the conveyance mechanism, the print medium picked up from the paper cassette not shown is conveyed to the catch tray not shown via the plurality of inkjet heads 19. It should be noted that the paper cassette is a cassette for storing a plurality of print media. The catch tray is a tray for receiving the print medium discharged from the inkjet printer 1.

The pump 17 supplies ink to ink chambers of the inkjet heads 19 from an ink tank via an ink flow channel. The pump 17 is disposed on the ink flow channel formed of a tube which connects the ink tank and pressure chambers 32 (see FIG. 3) of piezoelectric actuators 36 forming the ink chambers of the inkjet heads 19.

The pump drive circuit 18 drives the pump 17 in accordance with an ink supply control signal input from the processor 22.

The inkjet heads 19 eject the ink to the print medium to form an image. Based on drive power and control signals supplied from the head controller 20, the inkjet heads 19 eject the ink to the print medium conveyed to the conveyance mechanism to thereby form the image. The plurality of inkjet heads 19 are disposed for colors of the ink so as to correspond to the colors such as cyan, magenta, yellow, and black.

The head controller 20 is a circuit which is coupled to the control unit 11, the power supply 21, and the host PC 2 to control the plurality of inkjet heads 19 coupled thereto. The head controller 20 controls the inkjet heads 19 to eject the ink from the piezoelectric actuators 36 in the inkjet heads 19 to form the image on the print medium.

The power supply 21 converts the AC power supplied from the commercial power supply into DC power of a DC voltage DCV. The power supply 21 supplies the DC power to each component of the inkjet printer 1 as the drive power.

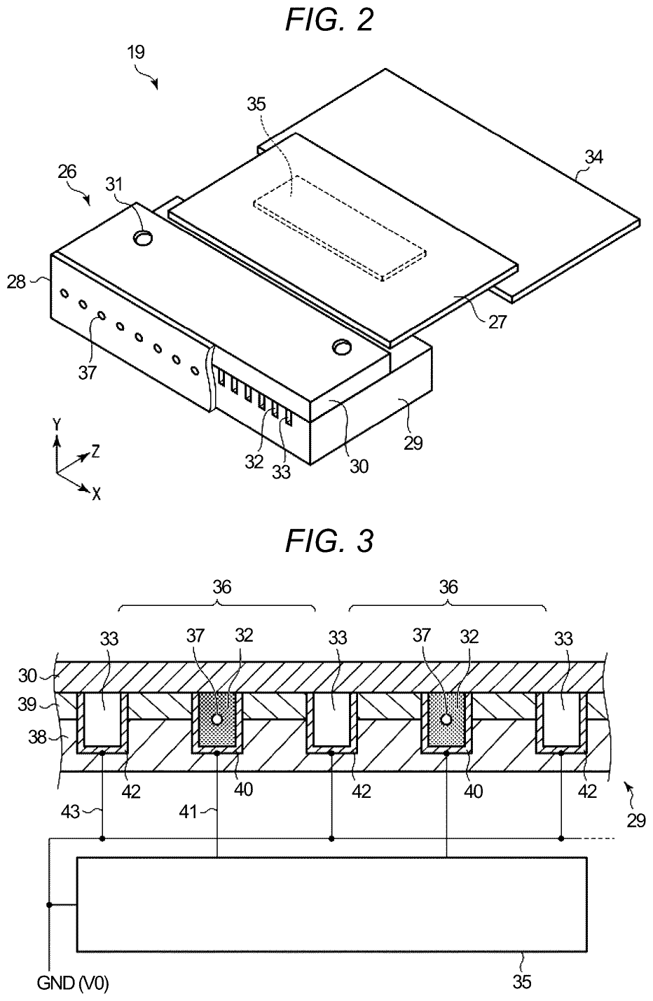

Subsequently, a configuration of the inkjet head 19 will be described. The inkjet head 19 has an in-head control circuit 24 and a head unit 25. In the head unit 25, a plurality of piezoelectric actuators 36 which eject the ink is disposed. The in-head control circuit 24 is a control circuit which controls this head unit 25. FIG. 2 is an external perspective view of the inkjet head 19, and FIG. 3 is a cross-sectional view of the piezoelectric actuators 36 provided to the inkjet head 19. The description will hereinafter be presented with reference to FIGS. 2 and 3.

As shown in FIG. 2, the inkjet heads 19 are each includes a nozzle head unit 26 as an example of a liquid ejection unit. The nozzle head unit 26 is coupled to a flexible printed-wiring board 27 as an example of a printed-wiring board provided with the in-head control circuit 24. The nozzle head unit 26 includes a nozzle plate 28, an actuator substrate 29, a sealing member 30, and an ink supply port 31. The sealing member 30 seals opening portions of the pressure chambers 32 and air chambers 33 provided to the actuator substrate 29. The ink supply port 31 is connected to the ink tank not shown via the ink flow channel not shown.

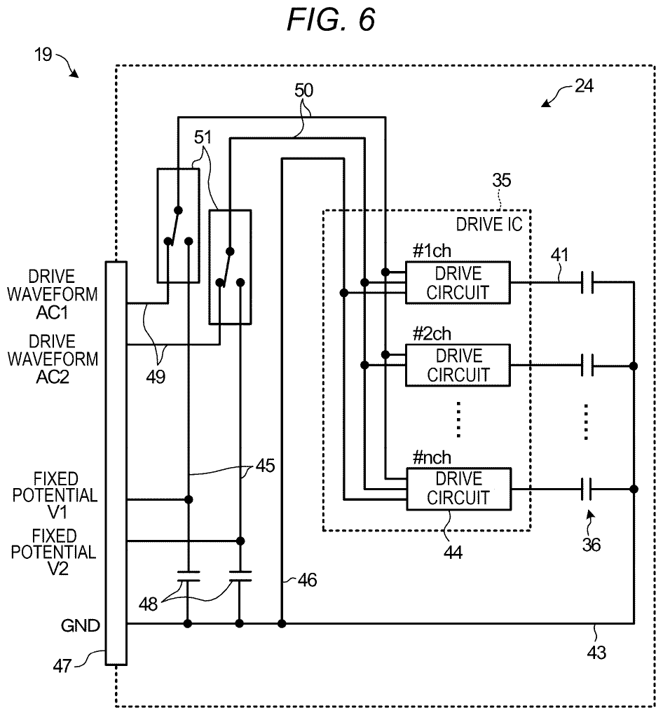

The flexible printed-wiring board 27 is coupled to the actuator substrate 29 of the nozzle head unit 26, and is coupled to a printed-circuit board 34 as a relay board via a connector 47 (see FIG. 6). A drive IC 35 provided to the in-head control circuit 24 is mounted on the flexible printed-wiring board 27. The drive IC 35 is a driver chip in which drive circuits 44 (see FIG. 6) dedicated to driving the plurality of piezoelectric actuators 36 of the head unit 25 are integrated with each other. The in-head control circuit 24 temporarily stores print data transmitted from the head controller 20 via the printed-circuit board 34, determines an operation of each of the piezoelectric actuators 36 of the channels in accordance with the print data, and then generates the control signal for performing the operation. The drive IC 35 uses the plurality of fixed voltages or the plurality of drive waveforms applied from the head controller 20 via the printed-circuit board 34 as input, and applies the drive signal to the piezoelectric actuator 36 of each of the channels so as to eject the ink at a predetermined timing based on the drive signal.

The nozzle plate 28 is a plate having a rectangular shape formed of resin such as polyimide or metal such as stainless steel. A plurality of nozzles 37 which eject the ink is formed on a surface of the nozzle plate 28. Nozzle density is set within a range of, for example, 150 to 1200 dpi.

The actuator substrate 29 is a substrate having a rectangular shape formed of, for example, ceramics having an insulating property. As shown in FIG. 3, the actuator substrate 29 includes a plurality of pressure chambers 32 of the ink and a plurality of air chambers 33 formed alternately along a first direction such as an X direction. The pressure chamber 32 is communicated with the corresponding nozzle 37. The pressure chambers 32 communicate with the ink supply port 31 via a common ink chamber (not shown) provided to, for example, the actuator substrate 29 or the sealing member 30. That is, the nozzle head unit 26 supplies the ink to each of the pressure chambers 32 through the ink supply port 31. That is, the nozzle head unit 26 functions as both the liquid ejection unit and a liquid supply unit. Meanwhile, the air chamber 33 arranged adjacent to the pressure chamber 32 is a closed space which does not communicate with the nozzle 37 and the common ink chamber (not shown). The pressure chamber 32 and the air chamber 33 are provided to the actuator substrate 29 by cutting out two piezoelectric members 38, 39 stacked in, for example, a direction (such as an opposed direction) in which the polarization directions conflict with each other in, for example, a rectangular groove shape in a second direction such as a Z direction. That is, the pressure chamber 32 and the air chamber 33 are separated using the piezoelectric member 38 and the piezoelectric member 39 stacked in a third direction such as a Y direction as a side wall.

An electrode 40 is integrally formed on a bottom surface and both side surfaces of the pressure chamber 32. The electrode 40 of the pressure chamber 32 is coupled to an individual interconnection 41 as a wiring member. An electrode 42 is integrally formed on a bottom surface and both side surfaces of the air chamber 33. The electrode 42 of the air chamber 33 is coupled to a common interconnection 43. That is, a connection point of the electrode 40 of the pressure chamber 32 and the individual interconnection 41 corresponds to one terminal of the piezoelectric actuator 36. A connection point of the electrode 42 of the air chamber 33 and the common interconnection 43 corresponds to the other terminal of the piezoelectric actuator 36. The electrodes 40 and the electrodes 42, the individual interconnections 41 and the common interconnections 43 are formed of, for example, a nickel thin film. The individual interconnections 41 are coupled to the drive IC 35 (i.e., the drive circuits 44 of the respective channels). The drive IC 35 applies drive voltages to the piezoelectric actuators 36 of the channels. The common interconnections 43 are coupled to a reference voltage (e.g., the ground (GND)). Due to this configuration, an electric field is applied, in a direction crossing (preferably perpendicular to) the polarization axis of the piezoelectric member 38 and the piezoelectric member 39, to the piezoelectric actuator 36 which provides the drive voltage, and the piezoelectric member 38 and the piezoelectric member 39 which form the side wall in the X direction of the piezoelectric actuator 36 deform symmetrically in the X direction in a shear mode.

That is, the pressure chamber 32 of the ink is sandwiched by a pair of piezoelectric actuators 36 each formed using the piezoelectric member 38 and the piezoelectric member 39 to have a columnar shape. By applying a voltage between both walls of the piezoelectric actuator 36 having the columnar shape, that is, an inside wall and an outside wall of the pressure chamber 32, to charge or discharge the piezoelectric actuator 36 which is a capacitive piezoelectric element using the piezoelectric member 38 and the piezoelectric member 39, the piezoelectric actuator 36 is deformed. That is, the piezoelectric member 38 and the piezoelectric member 39 drive the pressure chamber 32. Thus, the volume of the pressure chamber 32 changes, and as a result, ink pressure in the pressure chamber 32 changes. By controlling the magnitude and the timing of this change, an ink droplet is ejected from the nozzle 37.

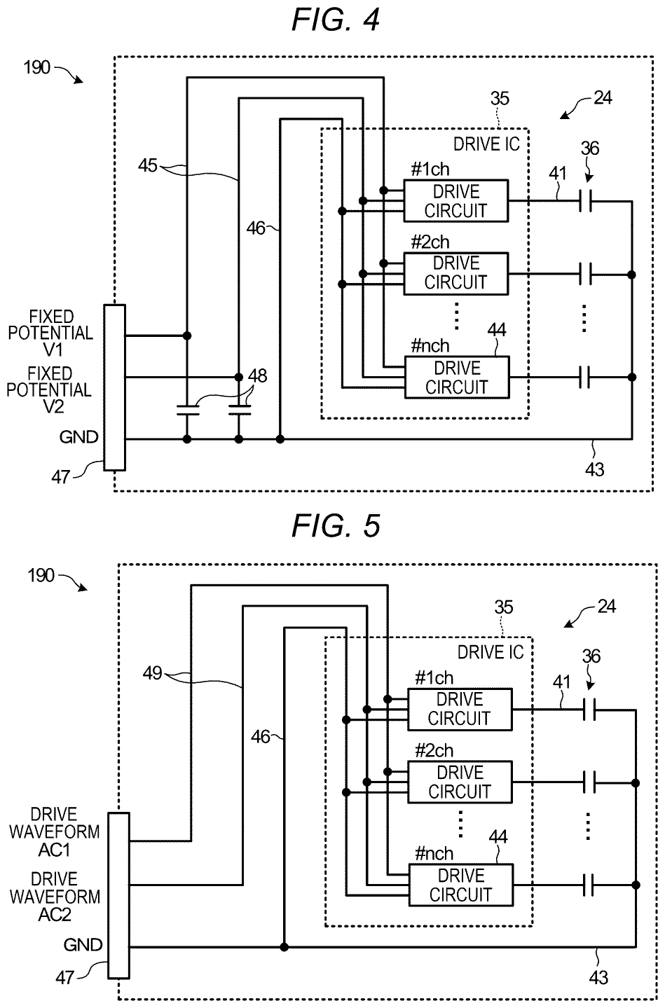

Then, a circuit configuration of the inkjet head 19 will be described. In advance of the description of the circuit configuration according to the present embodiment, first, a circuit configuration of a related-art inkjet head 190 will be described with reference to FIG. 4 and FIG. 5.

FIG. 4 is a diagram showing a circuit configuration in which the drive waveforms are generated inside a related-art inkjet head 190. The piezoelectric actuators 36 are coupled to the drive circuits 44 integrated into the drive IC 35 with the individual interconnections 41. The drive circuit 44 is coupled to two first power supply lines 45 and a reference (GND) voltage line 46. Further, the piezoelectric actuator 36 is coupled to the reference (GND) voltage line 46 with the common interconnection 43. The two first power supply lines 45 and the reference (GND) voltage line 46 are coupled respectively to input terminals not shown of the connector 47. To the input terminals of the connector 47, fixed voltages V1, V2 and the reference (GND) voltage are input from the head controller 20 via the printed-circuit board 34. The drive circuit 44 selects the first fixed voltages V1, V2 and the reference (GND) voltage input thereto to generate the drive waveform. The piezoelectric actuator 36 performs charging and discharging in accordance with the voltage to be selected and the voltage of the piezoelectric actuator 36 charged. Depending on the impedance of the power supply (or fixed voltage) lines input to the inkjet head, the charging and the discharging become too late in some cases. In order to prevent this, drive auxiliary capacitors 48 are coupled to the first power supply lines 45 to reduce the influence of the impedance.

FIG. 5 is a diagram showing a circuit configuration in which the drive waveforms are generated outside the related-art inkjet head 190. In this case, the drive circuits 44 are coupled to two second power supply lines 49 and the reference (GND) voltage line 46. The two second power supply lines 49 and the reference (GND) voltage line 46 are coupled respectively to input terminals not shown of the connector 47. To the input terminals not shown of the connector 47, drive waveforms AC1, AC2 and the reference (GND) voltage are input from the head controller 20 via the printed-circuit board 34. The drive circuit 44 selects the drive waveforms AC1, AC2 and the reference (GND) voltage input thereto to input the result to the piezoelectric actuator 36 via the individual interconnection 41. Since the higher the capacitance is, the more the drive waveform formation in the outside of the inkjet head 190 becomes difficult, the drive auxiliary capacitors 48 are not coupled.

As described above, due to the difference in presence or absence of the drive auxiliary capacitors 48, it is impossible to achieve both the internal waveform generation shown in FIG. 4 and the external waveform selection shown in FIG. 5.

FIG. 6 is a circuit configuration diagram of the inkjet head 19 according to the first embodiment. The piezoelectric actuators 36 are coupled to the drive circuits 44 integrated into the drive IC 35 with the individual interconnections 41. The drive circuits 44 are coupled to two power supply lines 50 and the reference (GND) voltage line 46. Further, the piezoelectric actuator 36 is coupled to the reference (GND) voltage line 46 with the common interconnection 43. The reference (GND) voltage line 46 is coupled to an input terminal not shown of the connector 47. Each of the power supply lines 50 is coupled to an output terminal of a selection circuit 51 as a two-input selection switch. One input terminal of the selection circuit 51 is coupled to the first power supply line 45, and the other input terminal of the selection circuit 51 is coupled to the second power supply line 49. Therefore, the selection circuit 51 switches a coupling destination of the power supply line 50 between the first power supply line 45 and the second power supply line 49. The two selection circuits 51 select the same input terminal. The first and second power supply lines 45, 49 are coupled to input terminals not shown of the connector 47. To the input terminals of the connector 47, fixed voltages V1, V2 and the reference (GND) voltage, and the drive waveforms AC1, AC2 are input from the head controller 20 via the printed-circuit board 34. Further, the drive auxiliary capacitors 48 are coupled to the first power supply lines 45.

It should be noted that the selection circuit 51 is a physical switch component, and is capable of switching the input to be selected when being installed in, for example, the inkjet printer 1. Alternatively, the selection circuit 51 may be a circuit using a semiconductor switch element such as a field effect transistor (FET), a metal oxide semiconductor (MOS), or a Photo MOS. Selection control of this semiconductor switch element may be performed by the drive IC 35, or may be performed by the processor 22 via the connector 47. It should be noted that the selection of the selection circuit 51 may be the same in the plurality of inkjet heads 19 provided to the inkjet printer 1, or may be different in some inkjet heads 19. That is, the selections of the selection circuits 51 may be made different in accordance with installation places or purposes of the inkjet heads 19.

The drive auxiliary capacitors 48 need to have sufficiently higher capacitances than that of the piezoelectric actuators 36 to be coupled via the drive circuits 44. When the drive auxiliary capacitors 48 are not high, the voltage instantaneously drops due to influences of the number of drive circuits 44 and the power supply impedance, and crosstalk increases. A difference in load of the piezoelectric actuator 36 between when the number of drive circuits 44 is 1 channel and when the number of drive circuits 44 is all channels contributes to the crosstalk. In order to reduce this, each of the drive auxiliary capacitors 48 has a capacitance at least no lower than that of the piezoelectric actuators 36 to be coupled via the drive circuits 44. Further, the drive auxiliary capacitors 48 are not coupled to the second power supply lines 49 at the drive waveform selection side. This is because an extra drive capacity necessary to externally generate the drive waveforms is required.

The inkjet head 19 according to the first embodiment includes the nozzle plate 28 in which the plurality of nozzles 37 for ejecting the ink is arranged, the piezoelectric actuators 36 disposed so as to correspond respectively to the nozzles 37, the drive circuits 44 which provide each of the plurality of piezoelectric actuators 36 with the drive waveform according to the ejection of the ink from the nozzle 37 corresponding to that piezoelectric actuator 36, the first power supply lines 45 to which fixed specific potentials are input, and which are coupled to the drive circuits 44, the second power supply lines 49 to which the drive waveforms AC1, AC2 common to the plurality of piezoelectric actuators 36 are input, and which are coupled to the drive circuits 44, the drive auxiliary capacitors 48 to be coupled to the first power supply lines 45, and the selection circuits 51 for selecting whether to couple the first power supply lines 45 and the drive auxiliary capacitors 48 to the drive circuits 44. Further, the drive auxiliary capacitors 48 each have a capacitance no lower than the sum of all the plurality of piezoelectric actuators 36 to which the drive circuits 44 are coupled, and the drive circuits 44 generate the drive waveforms using the input from either one of the first and second power supply lines 45, 49.

Therefore, according to the inkjet head 19 of the first embodiment, since it becomes possible to switch, by the selection of the selection circuits 51, between the method of selecting the appropriate potential from the plurality of fixed voltages V1, V2 and the reference (GND) voltage to generate the drive waveforms, and the method of selecting the common drive waveforms AC1, AC2 and the reference (GND) voltage, it is possible to provide the liquid ejection head that can be used in a wide range of environments and applications. That is, it becomes possible to adopt an optimum drive waveform with the common circuit, and it is possible to ensure the printing quality in the inkjet printer 1 of a variety of types.

It should be noted that in the inkjet head 19 according to the first embodiment, the drive auxiliary capacitors 48 are not coupled to the second power supply lines 49, that is, the second power supply lines 49 are unloaded.

Therefore, according to the inkjet head 19, it is possible to eliminate the necessity of forming the drive waveforms AC1, AC2 high in drive capacity which is required for the circuit outside the inkjet head 19, such as the head controller 20.

Further, in the inkjet head 19, the selection circuit 51 may be a selection switch which switches the input of the drive circuits 44 between the first power supply lines 45 and the second power supply lines 49.

### Modified Example

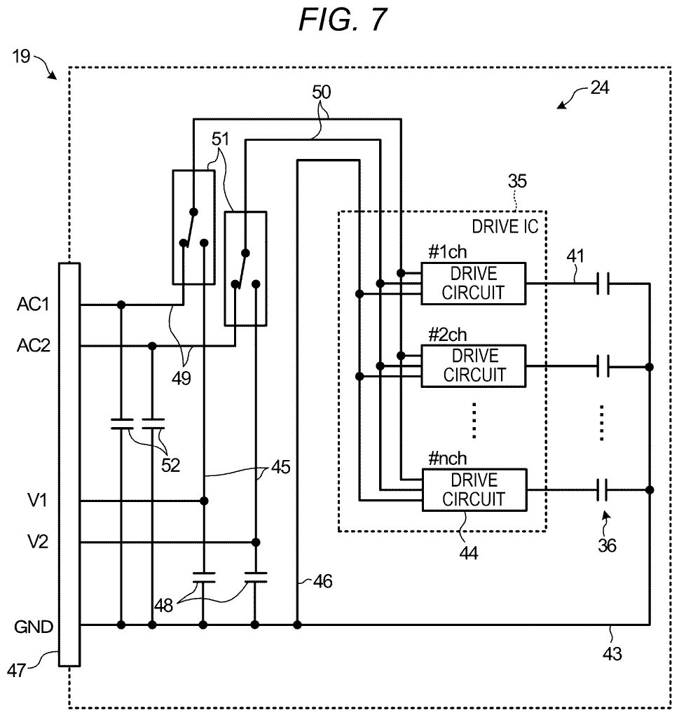

FIG. 7 is a circuit configuration diagram of the inkjet head 19 according to a modified example of the first embodiment. The drive auxiliary capacitors 48 are not coupled to the second power supply lines 49 in the first embodiment, but bypass capacitors 52 having a capacitance so low as to fail to affect the drive waveforms AC1, AC2 input from the outside may be coupled as shown in FIG. 7.

These bypass capacitors 52 remove high-frequency noise and suppress a resonance. The capacitance of the bypass capacitor 52 is lower than the capacitance of the piezoelectric actuators 36 to be coupled through the drive circuits 44.

As described above, the inkjet head 19 according to the modified example of the first embodiment further includes the bypass capacitors 52 to be coupled to the second power supply lines 49, and the capacitance of the bypass capacitor 52 may be lower than the sum of all the plurality of piezoelectric actuators 36 to which the drive circuits 44 are coupled.

### Second Embodiment

Then, an inkjet head 19 according to a second embodiment will be described. It should be noted that the detailed description of constituents substantially the same as those of the first embodiment will be omitted.

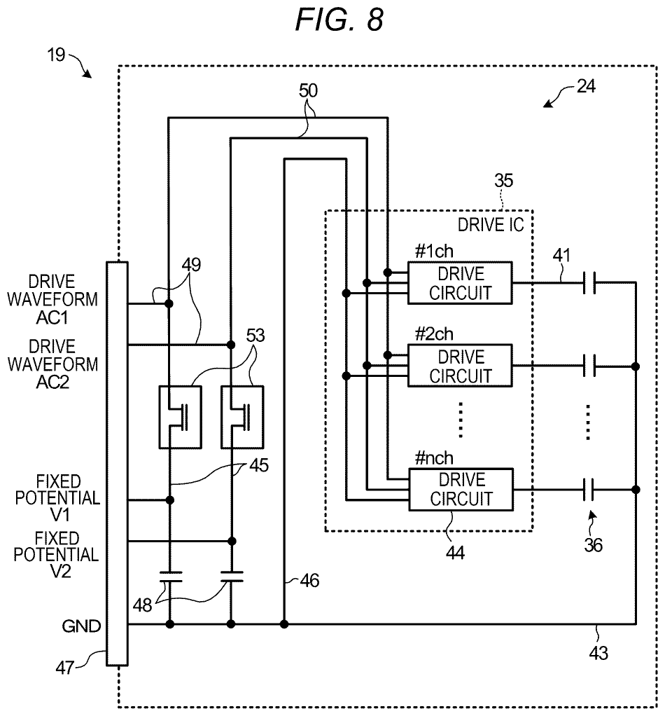

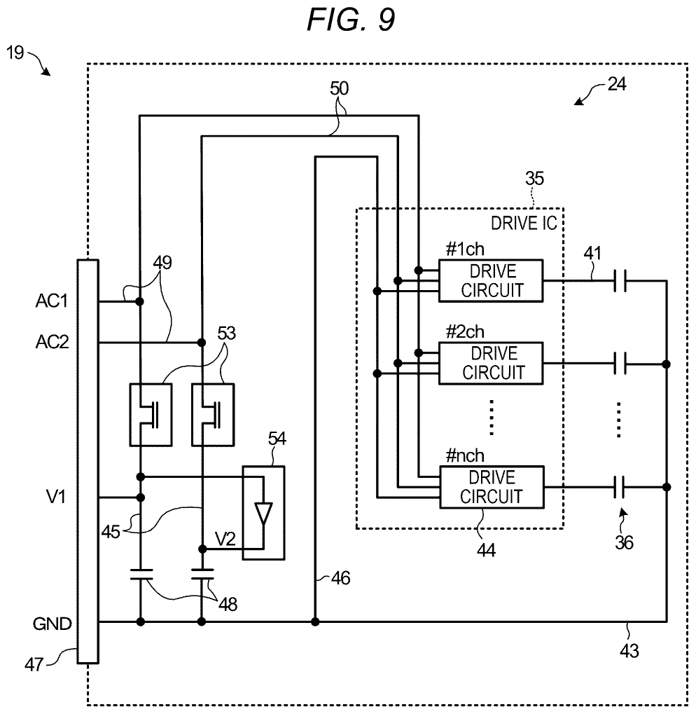

FIG. 8 is a circuit configuration diagram of the inkjet head 19 according to the second embodiment. In the second embodiment, each of the power supply lines 50 is coupled to the first power supply line 45 via a selection circuit 53, and is directly coupled to the second power supply line 49. The selection circuit 53 may be an ON-OFF switch. As the ON-OFF switch, a semiconductor switch element such as an FET, an MOS, or a Photo MOS can be adopted. Therefore, the selection circuit 53 switches between connection and disconnection of the first power supply line 45 and the drive auxiliary capacitor 48 to the power supply line 50, that is, the drive circuits 44. Selection control of this semiconductor switch element may be performed by the drive IC 35, or may be performed by the processor 22 via the connector 47. ON-OFF operations of the two selection circuits 53 are synchronized with each other.

The inkjet head 19 according to the second embodiment includes the nozzle plate 28 in which the plurality of nozzles 37 for ejecting the ink is arranged, the piezoelectric actuators 36 disposed so as to correspond respectively to the nozzles 37, the drive circuits 44 which provide each of the plurality of piezoelectric actuators 36 with the drive waveform according to an amount of the ink ejected from the nozzle 37 corresponding to that piezoelectric actuator 36, the first power supply lines 45 to which fixed voltages are input, and which are coupled to the drive circuits 44, the second power supply lines 49 to which the drive waveforms AC1, AC2 common to the plurality of piezoelectric actuators 36 are input, and which are coupled to the drive circuits 44, the drive auxiliary capacitors 48 to be coupled to the first power supply lines 45, and the selection circuits 53 for selecting whether to couple the first power supply lines 45 and the drive auxiliary capacitors 48 to the drive circuits 44. Further, the drive auxiliary capacitors 48 each have a capacitance no lower than the sum of all the plurality of piezoelectric actuators 36 to which the drive circuits 44 are coupled, and the drive circuits 44 generate the drive waveforms using the input from either one of the first and second power supply lines 45, 49.

Therefore, according also to the inkjet head 19 of the second embodiment, since it becomes possible to switch, by turning ON or OFF the selection circuits 53, between the method of selecting the appropriate potential from the plurality of fixed voltages V1, V2 and the reference (GND) voltage to generate the drive waveforms, and the method of selecting the common drive waveforms AC1, AC2 and the reference (GND) voltage, it is possible to provide the liquid ejection head capable of being installed at any places for any purposes. That is, it becomes possible to adopt an optimum drive waveform with the common circuit, and it is possible to ensure the printing quality in the inkjet printer 1 of a variety of types.

It should be noted that in the present second embodiment, the selection circuit 53 is an ON-OFF switch which switches between connection and disconnection of the first power supply line 45 and the drive auxiliary capacitor 48 to the drive circuits 44.

Therefore, according to the inkjet head 19 of the second embodiment, since the selection circuits 53 for switching between ON and OFF are sufficient, the number of terminals and the size can be reduced.

### Modified Example

FIG. 9 is a circuit configuration diagram of an inkjet head 19 according to a modified example of the second embodiment. In the present modified example, the inkjet head 19 includes a step-down circuit 54. The fixed potential V1 input to one of the two first power supply lines 45 is input to the step-down circuit 54, and the step-down circuit 54 steps down the fixed voltage V1 to generate the fixed voltage V2. Then, the step-down circuit 54 applies the fixed voltage V2 thus generated to the other first power supply line 45. Therefore, the fixed voltage V2 is not input to the connector 47. The step-down circuit 54 is a DC-DC converter such as a linear regulator or a switching regulator. It should be noted that in order to stabilize the step-down circuit 54, it is necessary to provide a sufficiently high capacitance at an input side and an output side. This capacitance can also be used as the drive auxiliary capacitor 48.

As described above, in the inkjet head 19 in the modified example of the second embodiment, one of the fixed voltages is generated by the step-down circuit 54 inside the inkjet head 19. Thus, it is possible to reduce the number of power supply lines input from the head controller 20.

However, in the present modified example, it is necessary to pay attention to the drive waveforms generated by the drive circuits 44 to which the fixed voltage V2 is applied. The fixed voltage V2 charges and discharges the piezoelectric actuators 36, and is smoothed by the drive auxiliary capacitor 48. Therefore, the step-down circuit 54 is required to have a sufficient capacity for the charging and discharging current thus smoothed.

It should be noted that the step-down circuit 54 may be formed by a unit IC, or can be incorporated in the same drive IC 35 as the drive circuits 44 of the channels.

The first and second embodiments and the modified examples thereof are hereinabove described, but embodiments of the disclosure are not limited thereto.

For example, the piezoelectric actuator 36 may be of a laminate type in which a plurality of piezoelectric bodies are stacked on one another, or may be a piezoelectric actuator having a single layer piezoelectric body.

The inkjet head 19 of the inkjet printer 1 is described as an example of a liquid ejection device in the embodiments and modified examples described above, but the liquid ejection device may be a shaping material ejection head of a 3D printer, or a sample ejection head of a dispensing apparatus.

While certain embodiments have been described, these embodiments have been presented by way of example only and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. A liquid ejection head comprising:
a nozzle plate including a plurality of nozzles;
a plurality of pressure chambers, each of which is capable of storing liquid and communicates with a corresponding one of the nozzles, a volume of each pressure chamber being varied to eject the liquid from the corresponding nozzle;
a plurality of piezoelectric elements, each of which is configured to vary the volume of a corresponding one of the pressure chambers in response to a drive signal;
an integrated circuit configured to generate the drive signal;
a first power supply line through which a first voltage is supplied, a voltage level of the first voltage being held constant;
a second power supply line through which a second voltage is supplied, a voltage level of the second voltage being varied and applicable to all of the piezoelectric elements;
a first capacitor connected to the first power supply line; and
a first switch circuit configured to selectively connect the integrated circuit to either the first or second power supply lines, wherein
the integrated circuit generates the drive signal using either the first voltage or the second voltage supplied through one of the first and second power supply lines that is selected by the first switch circuit, and
a capacitance of the first capacitor is no less than a total capacitance of all of the piezoelectric elements.

2. The liquid ejection head according to claim 1, further comprising:
a second capacitor connected to the second power supply line, wherein
a capacitance of the second capacitor is less than the total capacitance of all of the piezoelectric elements.

3. The liquid ejection head according to claim 2, wherein
the first and second capacitors are connected in parallel to the first switch circuit.

4. The liquid ejection head according to claim 1, further comprising:
a connector to which the second voltage is supplied, wherein
the second power supply line directly connects the connector to the first switch circuit.

5. The liquid ejection head according to claim 1, further comprising:
a connector to which the first voltage is supplied, wherein
the first power supply line directly connects the connector, the first switch circuit, and the first capacitor.

6. The liquid ejection head according to claim 1, further comprising:
a reference voltage line connected to the integrated circuit and through which a reference voltage is supplied, wherein
the integrated circuit generates the drive signal using the reference voltage and either the first voltage or the second voltage.

7. The liquid ejection head according to claim 6, wherein
the first capacitor is directly connected to the reference voltage line.

8. The liquid ejection head according to claim 1, wherein
the integrated circuit is configured to control the switch circuit.

9. The liquid ejection head according to claim 1, further comprising:
a third power supply line through which a third voltage is supplied, a voltage level of the third voltage being held constant and different from the voltage level of the first voltage;
a fourth power supply line through which a fourth voltage is supplied, a voltage level of the fourth voltage being varied and applicable to all of the piezoelectric elements;
a second capacitor connected to the third power supply line; and
a second switch circuit configured to selectively connect the integrated circuit to either the third or fourth power supply lines, wherein
the integrated circuit includes a first drive circuit connected to the first switch circuit and a second drive circuit connected to the second switch circuit.

10. The liquid ejection head according to claim 9, wherein
the first and second drive circuits are each configured to generate the drive signal to be applied to a corresponding one of the piezoelectric elements.

11. An inkjet printer comprising:
a motor configured to drive a roller for conveying a print medium; and
an inkjet head configured to eject ink onto the conveyed medium and including:
a nozzle plate including a plurality of nozzles,
a plurality of pressure chambers, each of which is capable of storing the ink and communicates with a corresponding one of the nozzles, a volume of each pressure chamber being varied to eject the ink from the corresponding nozzle,
a plurality of piezoelectric elements, each of which is configured to vary the volume of a corresponding one of the pressure chambers in response to a drive signal,
an integrated circuit configured to generate the drive signal,
a first power supply line through which a first voltage is supplied, a voltage level of the first voltage being held constant,
a second power supply line through which a second voltage is supplied, a voltage level of the second voltage being varied and applicable to all of the piezoelectric elements,
a first capacitor connected to the first power supply line, and
a first switch circuit configured to selectively connect the integrated circuit to either the first or second power supply lines, wherein
the integrated circuit generates the drive signal using either the first voltage or the second voltage supplied through one of the first and second power supply lines that is selected by the first switch circuit, and
a capacitance of the first capacitor is no less than a total capacitance of all of the piezoelectric elements.

12. The inkjet printer according to claim 11, wherein
the inkjet head further includes a second capacitor connected to the second power supply line, and
a capacitance of the second capacitor is less than the total capacitance of all of the piezoelectric elements.

13. The inkjet printer according to claim 12, wherein
the first and second capacitors are connected in parallel to the first switch circuit.

14. The inkjet printer according to claim 11, wherein
the inkjet head further includes a connector to which the second voltage is supplied, and
the second power supply line directly connects the connector to the first switch circuit.

15. The inkjet printer according to claim 11, wherein
the inkjet head further includes a connector to which the first voltage is supplied, and
the first power supply line directly connects the connector, the first switch circuit, and the first capacitor.

16. The inkjet printer according to claim 11, wherein
the inkjet head further includes a reference voltage line connected to the integrated circuit and through which a reference voltage is supplied, and
the integrated circuit generates the drive signal using the reference voltage and either the first voltage or the second voltage.

17. The inkjet printer according to claim 16, wherein
the first capacitor is directly connected to the reference voltage line.

18. The inkjet printer according to claim 11, wherein
the integrated circuit is configured to control the switch circuit.

19. The inkjet printer according to claim 11, wherein
the inkjet head further includes:
a third power supply line through which a third voltage is supplied, a voltage level of the third voltage being held constant and different from the voltage level of the first voltage,
a fourth power supply line through which a fourth voltage is supplied, a voltage level of the fourth voltage being varied and applicable to all of the piezoelectric elements,
a second capacitor connected to the third power supply line, and
a second switch circuit configured to selectively connect the integrated circuit to either the third or fourth power supply lines, and
the integrated circuit includes a first drive circuit connected to the first switch circuit and a second drive circuit connected to the second switch circuit.

20. The inkjet printer according to claim 19, wherein
the first and second drive circuits are each configured to generate the drive signal to be applied to a corresponding one of the piezoelectric elements.
